(19) United States
(12) Patent Application Publication
(10) Pub. No.: US 2021/0308772 A1
(43) Pub. Date: Oct. 7, 2021

(54) Mini wheel CNC lathe and Straightener

(71) Applicant: Brian Len, Coral Springs, FL (US)

(72) Inventor: Brian Len, Coral Springs, FL (US)

(21) Appl. No.: 16/841,924

(22) Filed: Apr. 7, 2020

(51) Int. Cl. B23B 5/28; B23B 3/02; B23B 3/16; B24B 45/00; B21D 53/30

(52) U.S. Cl. CPC B23B 5/28; B23B 3/02; B21D 53/30; B24B 45/003; B23B 3/161

(57) ABSTRACT

The present invention is a mini wheel CNC and manual lathe with wheel straightener and method for using said lathe.

### BACKGROUND

Wheel lathes are complex and important systems. A significant problem exists in that the machines typically are not portable as they require stability for precision cutting.

The present invention provides not only a machine that is portable, but a machine that allows a rim to be straightened while the tire remains on the rim.

### SUMMARY OF THE INVENTION

The Mini Wheel CNC and Manual Lathe with Wheel Straightener.

### Overview

A small machine that will serve multiple purposes as a wheel straightener, a CNC lathe and a manual lathe in one.

The straightener has new improved functions that allow far more angles and methods than before.

The lathe, being very small has the ability to fit in tight spots such as a trailer or truck and or a small workshop. It can also now be powered by low amperage single phase electrical current making it a great candidate for areas where power is not in abundance like a mobile location.

The machine includes chuck which mostly secures the wheel to the machine by bolting as you would on a motor vehicle. This would then eliminate many of the possibilities of the wheel coming off during machining. It also opens a new possibility of cutting a wheel with the tire on which in a mobile location is a great help.

### Purpose

There are multiple purposes for this machine which will primarily be used in the automotive industry in the remanufacturing of bent or scratched wheels. It can be used either independently or as a combination of a CNC lathe or a wheel press (straightener).

The machine has been built this way with certain reasoning in mind. Although there are other larger machines that serve this purpose in the industry, there is no machine that is small and also a combination of the various machines. Thus, a single machine will accomplish the tasks that at this point, require multiple machines. A real need to save space and cost without losing the abilities of the machines has become apparent. In staying with what is ideal and what is needed, this machine will be able to serve this purpose as it is a straightener and CNC/manual lathe in one, while still being smaller than most of the individual machines that serve in the industry at present. This opens up the possibility of this machine now being able to be mobile due to the lighter weight and space saving attribute. Although the machine can be mobile it is also possible to be placed on a shop floor as well which also brings down setup costs due to again to space, running costs and versatility.

In one embodiment, the present invention is a machine being a mini wheel CNC and manual lathe with wheel straightener comprising:
a main body;
a spindle associated with said main body, said spindle turned by a motor connected to a power source;
a cutting tool holder;
a control operatively associated with said cutting tool holder, whereby said control is a user selectable manual or computer operated control;
a base having an upper surface stage and two vertically positioned side panels supporting said upper surface stage, said stage constructed and arranged to dampen vibration and exhibiting a maximum deflection load during operation less than 0.0444 inches.

In one embodiment, stage deflection is between 0.001176 inches and 0.0444 inches.

In one embodiment, the spindle is constructed and arranged to hold a workpiece.

In one embodiment, the spindle is constructed and arranged to hold a tire on a rim.

In one embodiment, the spindle is constructed and arranged to hold a tire rim with tire mounted.

In one embodiment, the side panels exhibiting a maximum deflection load during operation less than 0.0666 inches.

In one embodiment, the side panels exhibiting a maximum deflection load during operation between 0.0002 inches and 0.0666 inches.

In one embodiment, the machine further includes a wheel straightening tool.

In one embodiment, a user selects using one of said wheel straightening tool or said cutting tool.

In one embodiment, a user powers on said machine and selects using one of said wheel straightening tool or said cutting tool and is able to switch from said wheel straightening tool or said cutting tool without stopping said machine or removing said rim. In one embodiment, the machine is configured with said lathe oriented vertically relative to a user which would result in said tire or rim being positioned in a horizontal orientation.

### BRIEF DESCRIPTION OF THE SEVERAL VIEWS OF THE DRAWINGS

FIG. 1 is the overall system according to what embodiment of the present invention.

FIG. 2 is an end view of the overall system from FIG. 1.

FIG. 3 is a partial end view of the probe system according to one embodiment of the present invention.

FIG. 4 is the system of FIG. 1 demonstrating a shoe mount assembly and headstock assembly.

FIG. 5 is a detailed side view of a shoe mount assembly according to what embodiment of the present invention.

FIG. 6 is in a large view of a shoe mount assembly according to one embodiment of the present invention.

FIG. 7 is a partial cross-section view along section lines X-X from FIG. 5.

FIG. 8 is a schematic demonstrative of Lines of force acting on the system of the present invention when in use.

FIG. 9 is a partial cross-section view demonstrative of Force applied on a top plate according to one about them in the present invention.

FIG. 10 is demonstrative of the vibratory offset of the horizontal walls.

FIG. 11 is a side view according to one embodiment of the present invention.

FIG. 12 is a side view demonstrating movement of load to work position according to one embodiment of the present invention.

FIG. 13 is a side view demonstrating workpiece position and movement according to one embodiment of the present invention.

FIG. 14 is a side view demonstrating workpiece position according to one embodiment of the present invention.

FIG. 15 is a side view demonstrating workpiece position according to one embodiment of the present invention.

FIG. 16 is a side partial cross section view demonstrating workpiece mounting according to one embodiment of the present invention.

FIG. 17 is a plan view of a bolt plate according to one embodiment of the present invention.

FIG. 18 is a plan view of a bolt plate according to one embodiment of the present invention.

FIG. 19 is a side partial cross section view of a bolt plate according to one embodiment of the present invention.

FIG. 20 is a plan view of a bolt plate according to one embodiment of the present invention.

FIG. 21 is a side partial cross section view of a bolt plate according to one embodiment of the present invention.

FIG. 22 is a side partial cross section view of a bolt plate according to one embodiment of the present invention.

FIG. 23a is a side view of a spindle according to one embodiment of the present invention.

FIG. 23b is a front view of a spindle according to one embodiment of the present invention.

FIG. 24a is a front view of a bolt plate according to one embodiment of the present invention.

FIG. 24b is a side partial cross section view of a bolt plate according to one embodiment of the present invention.

FIG. 24c is a front view of a spindle according to one embodiment of the present invention.

FIG. 24d is a side partial cross section view of a bolt plate according to one embodiment of the present invention.

FIG. 25 is a side view of an adapter ring according to one embodiment of the present invention.

FIG. 26 is a front view of an adapter ring according to one embodiment of the present invention.

FIG. 27 is a side view of an adapter ring according to one embodiment of the present invention.

FIG. 28 is a front view of an adapter ring according to one embodiment of the present invention.

FIG. 29 is a side view of an adapter ring according to one embodiment of the present invention.

FIG. 30 is a front

FIG. 31 is a side partial cross section view of a workpiece wheel rim mounting according to one embodiment of the present invention.

FIG. 32a is a side partial cross section view of a headstock assembly according to one embodiment of the present invention.

FIG. 32b is a front view of a bolt plate according to one embodiment of the present invention.

FIG. 33 is a side partial cross section view of an workpiece wheel rim mounting according to one embodiment of the present invention.

FIG. 34a is a side partial cross section view of a headstock assembly according to one embodiment of the present invention.

FIG. 34b is a front view of a bolt plate according to one embodiment of the present invention.

FIG. 35 is a side partial cross section view of a workpiece wheel rim mounting according to one embodiment of the present invention.

FIG. 36a is a front view of a centering cone according to one embodiment of the present invention.

FIG. 36b is a side partial cross section of a centering cone according to one embodiment of the present invention.

FIG. 36c is a rear view of a centering cone according to one embodiment of the present invention.

FIG. 37a is a front view of a centering cone according to one embodiment of the present invention.

FIG. 37b is a side partial cross section of a centering cone according to one embodiment of the present invention.

FIG. 37c is a rear view of a centering cone according to one embodiment of the present invention.

### DETAILED DESCRIPTION OF THE PREFERRED EMBODIMENT

### Method of Use

### Mounting of Wheel

There are a few options for mounting the wheel to the machine for either repairing or for use with the lathe either manually operated or via the CNC control.

### Option 1

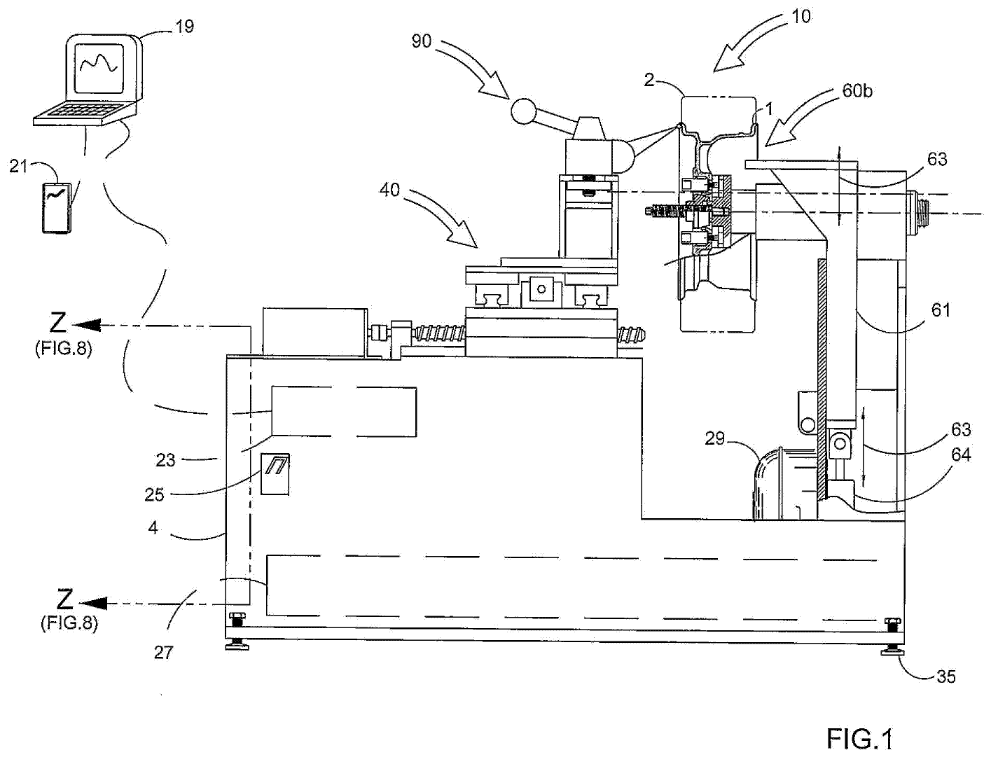

The wheel center hole is slid over the Centering shaft of machine until it butts up against the plate where “bolt holes” are located (FIG. 1)

A cone is selected from the various sizes provided (FIG. 1C) and slid over shaft (FIG. 1B) the center of the wheel thus holding and centralizing the wheel on the centralizing shaft. A retaining nut is then threaded onto the centralizing shaft which secures the cone against the wheel thus keeping and retaining the wheel in a central position on the shaft.

At this point it would be possible to make use of the machine with wheel secured in this manner although it is always recommended to fasten with the bolts as well listed below. The layout of the bolt holes on the plate (FIG. 1) is such that there is a combination of 2 or more holes in the “bolt pattern” for any standard motor vehicle available today. Also as the wheel retaining plate is replaceable, it can be taken off and a new one can be installed with the any desired bolt pattern as determined by an operator. The interchangeable configuration of the present invention results in a single machine able to form any desired plate. Once the wheel is centralized with the cone and retaining nut it can now be rotated to find corresponding holes and at this point two or more bolts can be inserted to secure and fasten the wheel to the wheel retaining hub.

It would again now be possible to use the machine at this point with the wheel fastened in this manner namely secured with the centering cone and at least 2 bolts.

On some wheels it could be necessary to be able to remove the centering shaft, retaining nut, centering cones and complete centering shaft can be removed while still leaving the wheel centrally located on the machine so that nothing impedes the center of the wheel making it possible for a tool to be able to pass by the center of the wheel. There is no such machine configured in this manner and allowing removal of the centering of shaft.

### Option 2

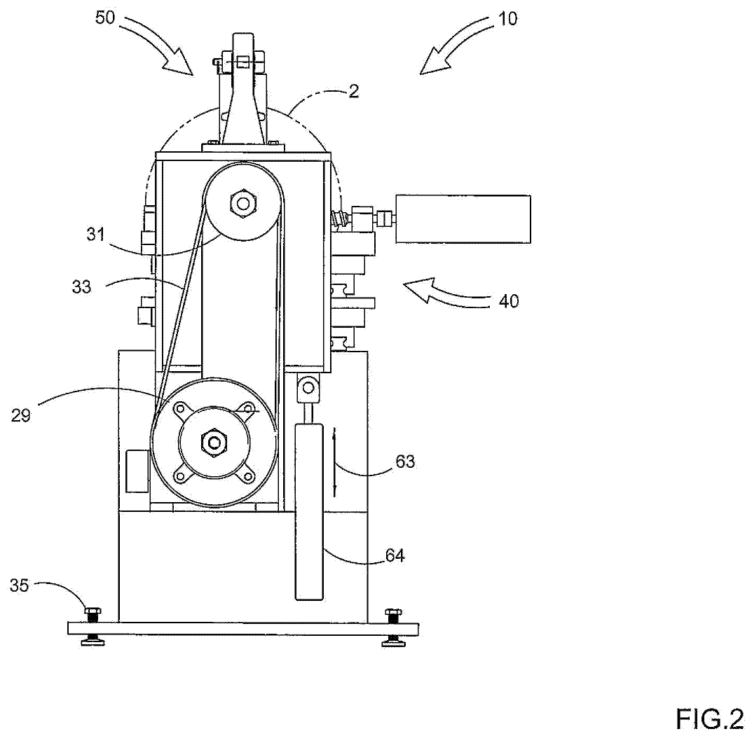

Option 2 would be a method whereby the center shaft will not be needed at all. On the removable and replaceable wheel retaining plate seen in FIG. 2, there is a uniform raised section centrally located around the circumference of the centering shaft. Now on all wheels today there is a hub center with varying sizes located in the back of the wheel which enables centralization of the wheel on the motor vehicle. A “centering ring” which is supplied with the “Mini Wheel CNC lathe and Straightener” which all have the same inner diameter as that of the raised section of bolt hole plate seen in FIG. 2, and which will correspond with the applicable wheel application being the vehicle manufacturer OD of the wheel hub of the vehicle, will now be inserted over the raised section as per FIG. 2 below. The back of the wheel can then be slid onto the “centering ring” which will keep the wheel in a central location on the machine. The wheel can be turned with the machine in a locked position so as to find 2 or more corresponding holes seen in FIG. 1B above in which bolts will be secured and thus fastening the wheel to the machine in a centrally located position.

FIG. 2 also indicated that one of the interchangeable hubs, instead of various holes there can be slots where a “T” nut can be slid and thus be able to fasten and secure the wheel to te machine.

### Option 3

Instead of a centering ring described above it is also possible for a self-centering 3 or 4 jaw chuck to perform the same function as the ring but with an adjustable OD (outer diameter). So the chuck could be fitted to the rear hub of the wheel but will have the same OD as either the Centralizing shaft on the machine or the raised section on plate shown in FIG. 2 above. The wheel could then be slid either onto the centralizing shaft or over the raised section, thus keeping and locating a central position on the machine.

One of the above methods would be used to secure the wheel to the machine and then at this time a number of functions can be performed.

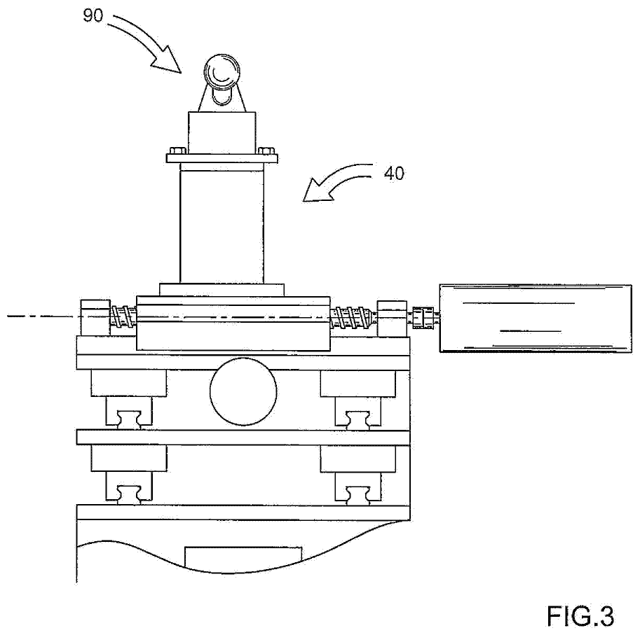

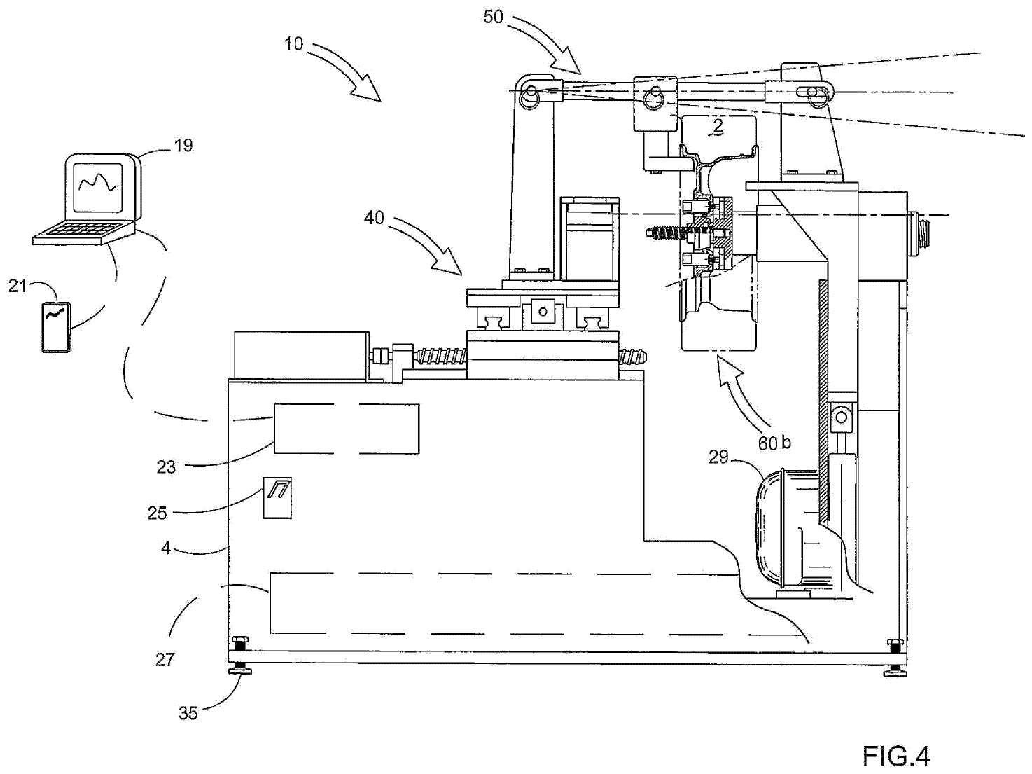

It is now possible to be able to check if the wheel is running true. Being that the centering shaft and hub plate are attached to a motor and pulley system (FIG. 3 below), the wheel can now rotate at a pre determined speed which will allow visual and possible measurements to be taken of the wheel. Should it be determined that the wheel is bent this can possibly be straightened with the aid and utilization of the straightening apparatus of the machine.

### Option 4

A 3 jaw self centering chuck can be attached if the need arises as all of options 1, 2 and 3 above can be removed for this purpose

### The Straightening Method:

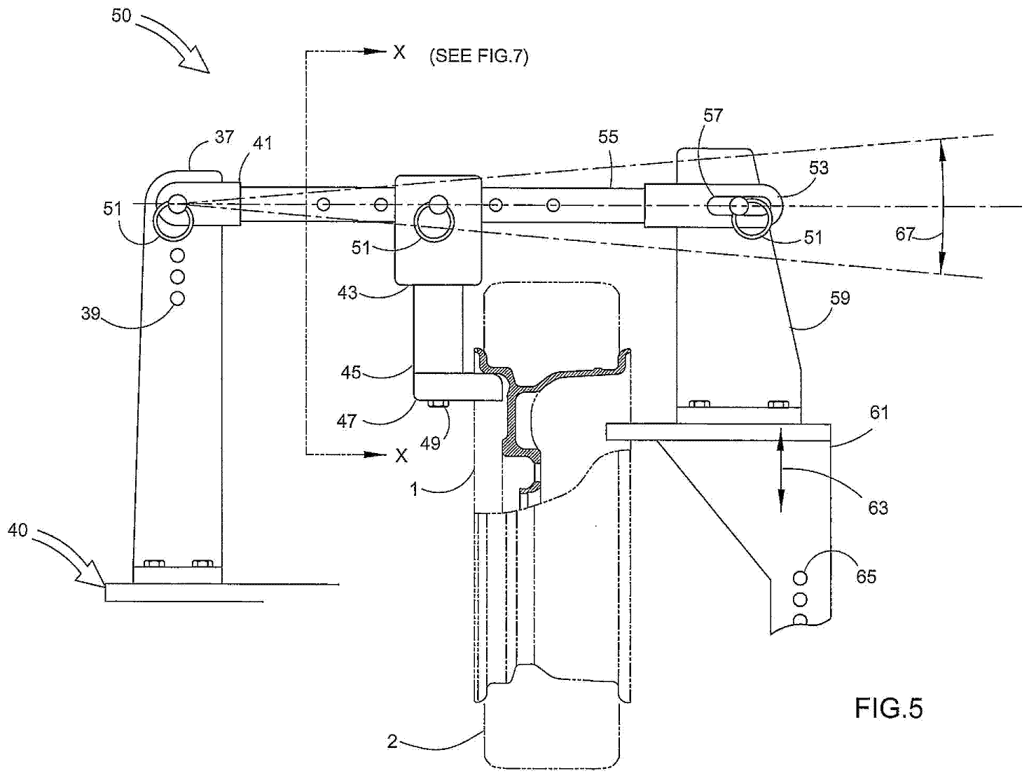

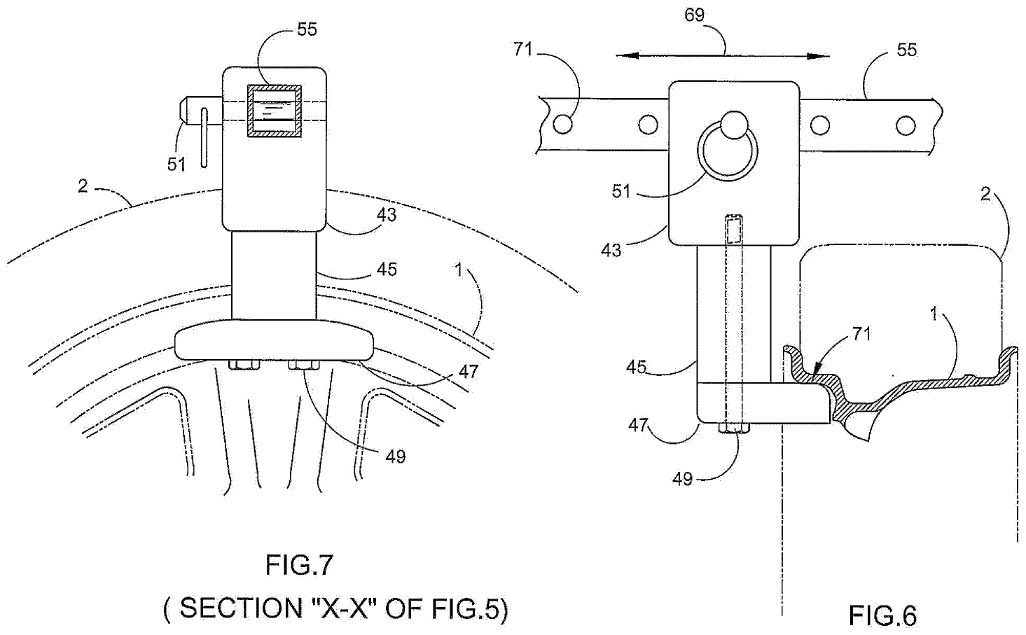

There is a platform located just behind the wheel hub plate that extends to the inner part of the wheel when it is mounted on the machine. This platform has travel in a vertical motion with the aid of a hydraulic cylinder located and attached below. See FIG. 5

Whilst the platform has the ability to move up and down with the wheel in place, this provides a method of asserting pressure on the wheel in specified and chosen areas within and around the wheel see FIG. 6.

This pressure can easily be moved around the inside and back of wheel with the loose shoe that sits upon the moving platform as illustrated.

Pressure can also be applied to the front of the wheel with adaption that can be added to the machine. See FIG. 7.

In FIG. 7, an extension can be attached to the platform and be extended through the spoke of the wheel so as to be able to apply pressure to the front thereof.

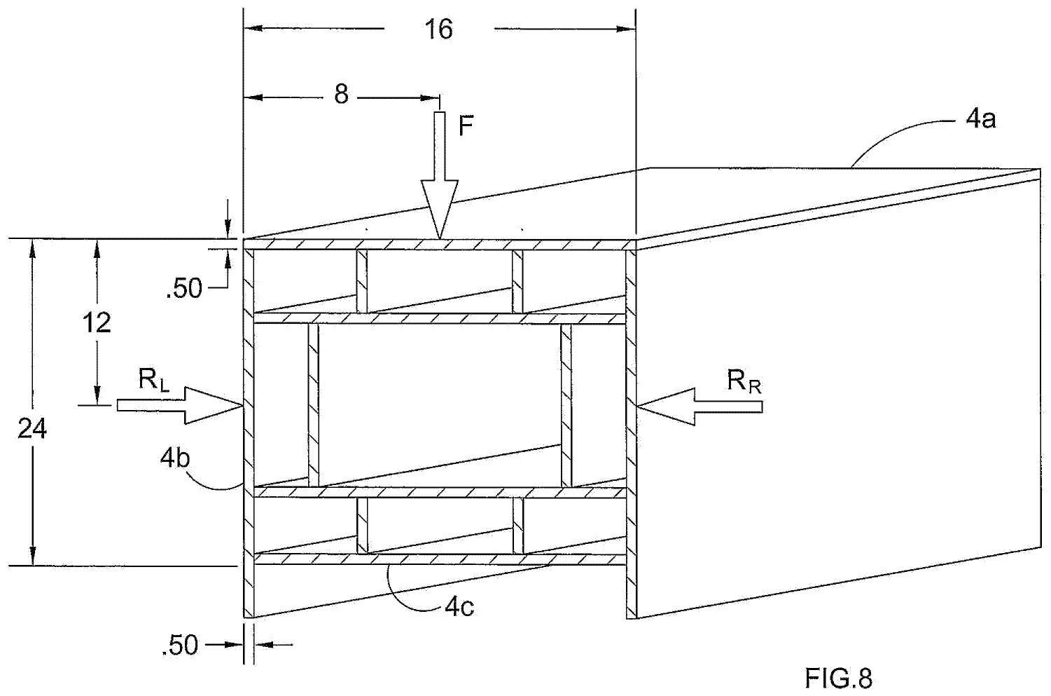

It will also be possible to insert pressure on the front of the wheel by attaching a removable arm to the base of the machine located in front of a mounted wheel that will be able to have an upward pushing motion as in FIG. 8.

In FIG. 8 there is an hydraulic ram attachment that can be placed between the base of the machine with and the top of the wheel with an interchangeable sized shoe.

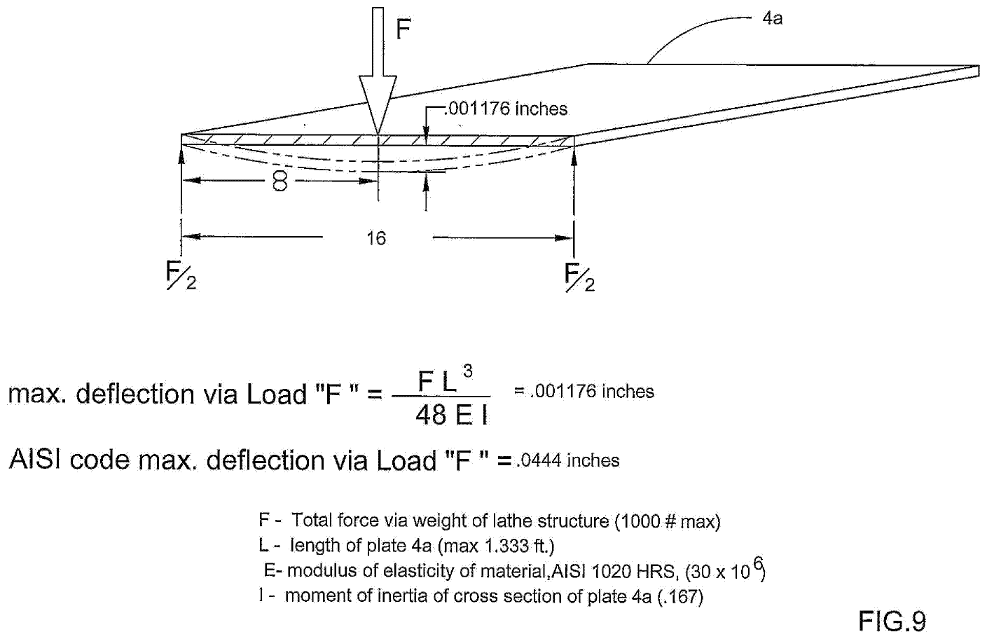

In FIG. 9 there is an hydraulic ram attachment that can be placed between the base of the machine with and the bottom of the wheel with an interchangeable sized shoe.

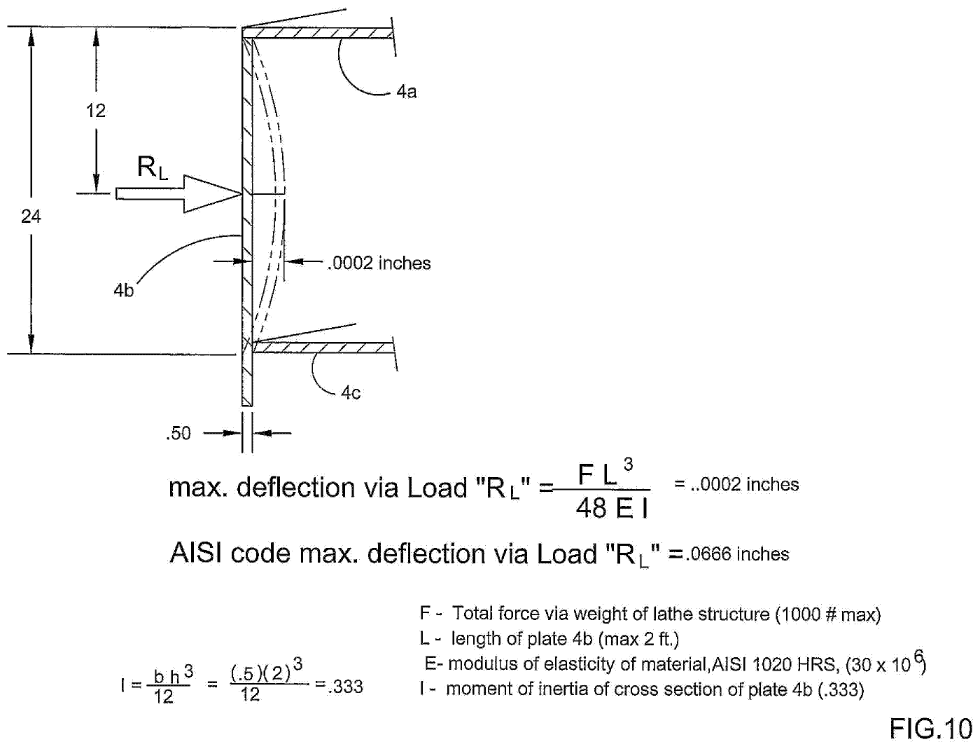

In FIG. 10 there is a removable and expandable hydraulic ram attachment that can be placed between the base/rear of the machine on a pivot point. This will then attach to an overhead removable attachment with a notched top or holes for a slide adjustment which will be able to be attached to a removeable and pivoted platform that can loosely be placed on top of the main machine hydraulic up and down movement. This will now allow a up and down movement but with the ability to change the angle and height of the overhanging support whereby an adjustable slide can be placed close to front of the wheel. This adjustable slide will have an adjustable attachment that will hang and have a Variable shaped shoe that will be able to make contact with the wheel and be able to apply upward pressure with the ability to adjust angle of the pull from above. This shoe attachment will be able to vary its angle as well with a pin system. This angle adjustment will allow a pressure to be applied in any direction needed which has never been entirely possible up to now.

### CNC/Manual Lathe Purpose

The combination of these two attributes is largely space saving and giving the ability to have more machines for less financial cost.

Many wheel shops have two lathes and with the space saving idea in mind you now only need one which is in fact much smaller than even one of the regular machines.

### CNC Purpose

The purpose of CNC lathe is to be able to firstly digitize or map out the shape of a wheel using a probe and proprietary software. Then to be able to follow that shape with a cutting tool on the machine that will allow a very light trim across the face of the wheel giving it back its original cosmetic finish.

### Proprietry Operating System

The operating system of the machine will be that of a wheel lathe that has been designed for this purpose

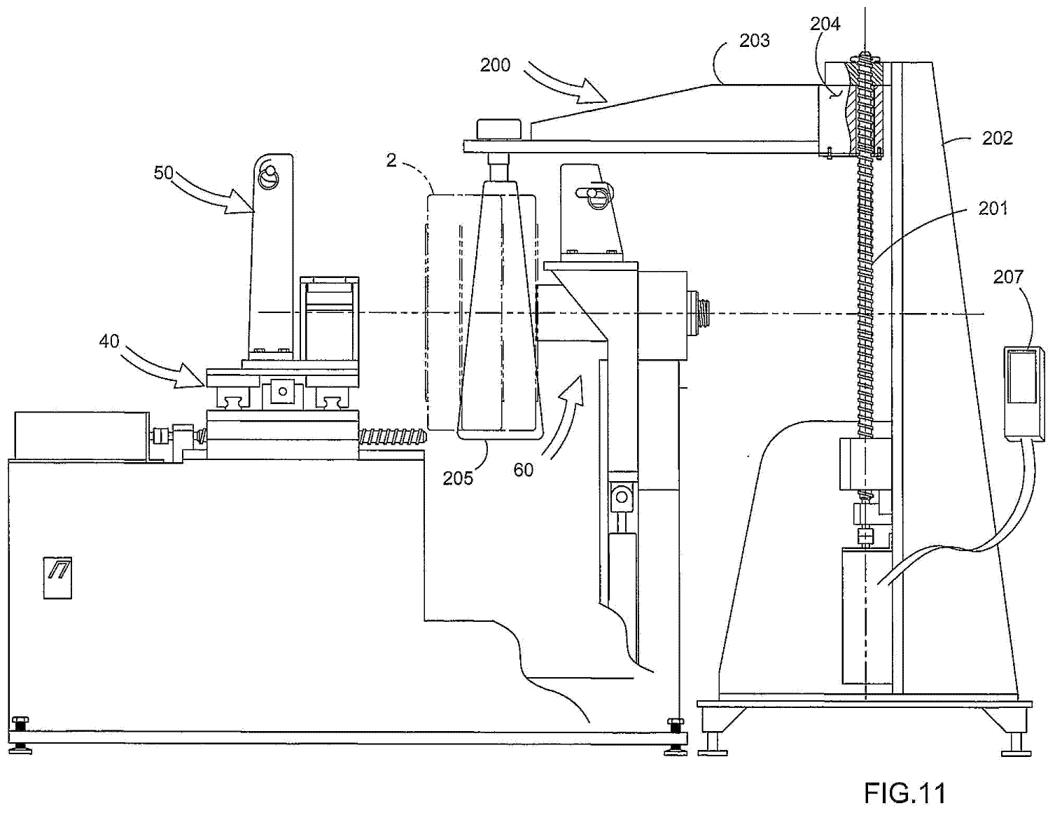

### Manual Lathe Purpose and Method as FIG. 11

In one embodiment, the machine will include a configuration for manual operation of the lathe in an electronic configuration. This will allow the operator to manually adjust movement on the tool post without any electrical motor assist. This allows a feel of resistance so as to be able to judge how deep a cut is being made.

### Combination Lathe

### Size:

This machine is a number of machines in one with many purposes and methods of completing intended tasks. The size of this machine is smaller than any one of the machines it can replace in a workshop.

### Stability

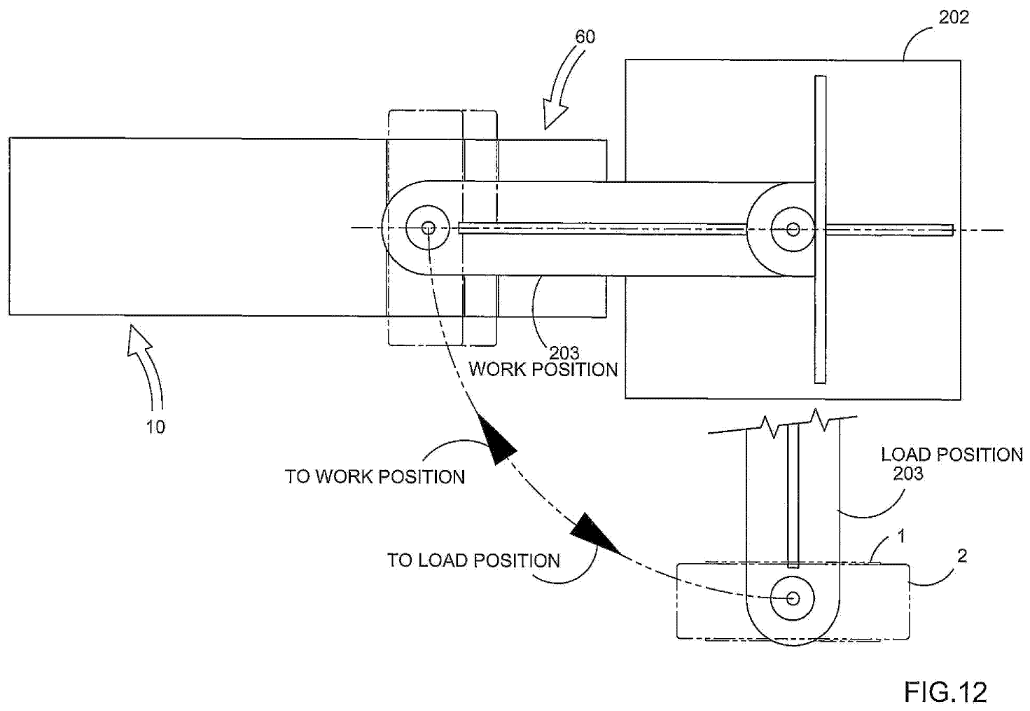

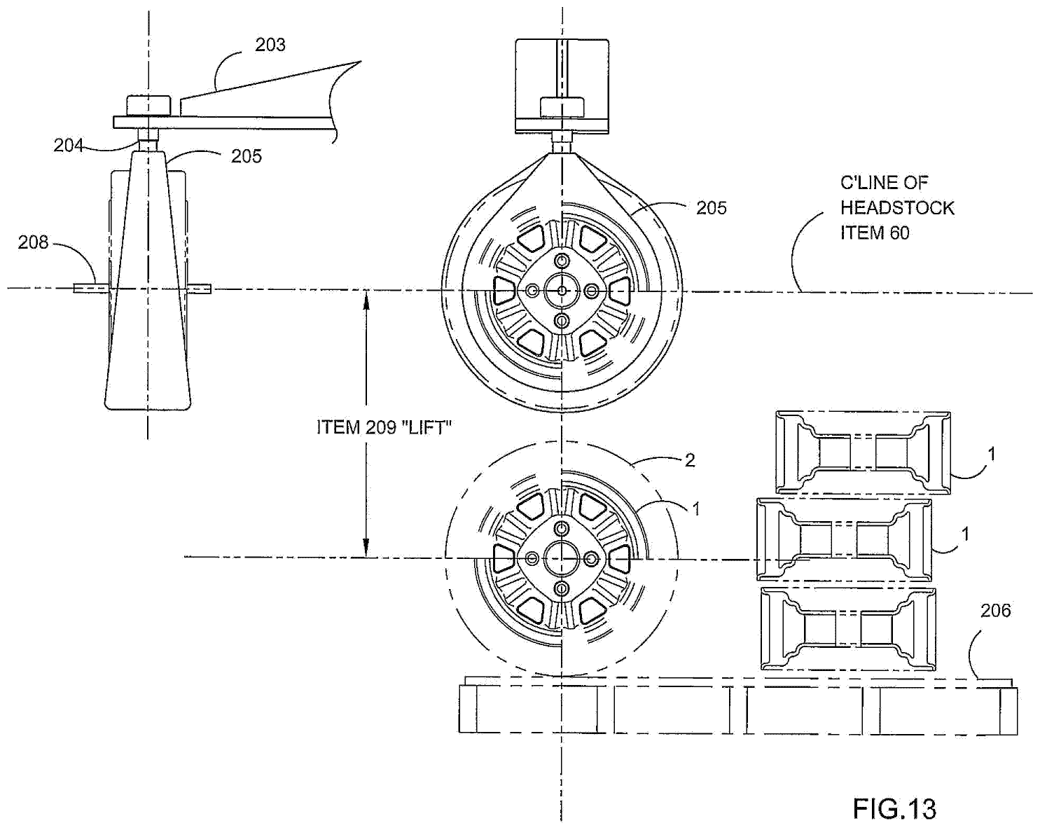

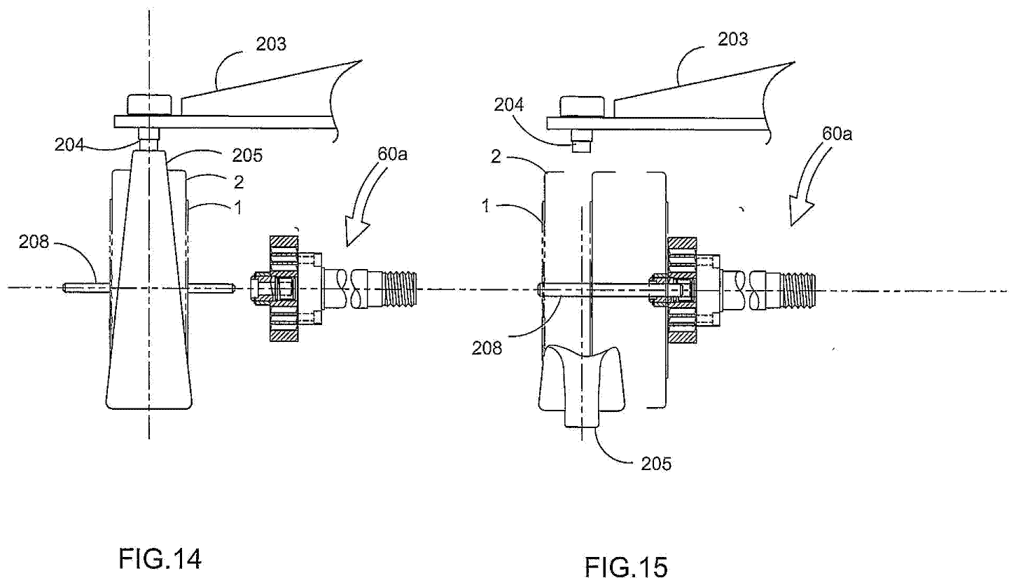

The entire machine has been designed as a brace system with the ability to fill various pockets as desired. In one embodiment, where it is desired to keep the overall weight of the machine as low as possible, there is no extra weight added. In another embodiment, the user will fill the pockets with concrete to deaden and dull any vibration that may occur, See FIG. 12.

### Electrical Current Draw Reduced

As a result of finding the smallest motors that will do the job intended, the current draw and consumption will be considerably less than most other machines. Also it now has the possibility of being a mobile machine as it is possible to run on single phase power as well which almost any small generator can handle

The System 10 where automotive rim 1 is on tire 2. Although the figures demonstrate use with a tire, it is contemplated the machine functions using a rim 1 alone. As understood and stated herein, one significant novelty of the present invention provides a system whereby the rim is worked either with or without a mounted tire.

System 10 is supported on base frame 4, base frame 4 having a base frame top mount plate 4A, a base frame side mount plate 4B, a base frame lower shelf 4C.

Center mount shaft 5 supports rim 1. In one embodiment, cone 17, being a centering cone, supports rim 1 onto center mount shaft 5. In another embodiment, mounting bolt 7A mounts through rim 1 onto bolt plate 102. In an embodiment utilizing mounting bolt 7A, bolt plate 102A is configured to receive and attach utilizing mounting bolt 7A.

As demonstrated in FIG. 1, head stock assembly 60B, constructed and arranged to impart vertical motion as indicated by arrow 63, allows the user to selectively move the head stock assembly as desired. Front base 51 for shoe assembly 50 is part of system 60B. Additionally, motor 29 provides rotational motion to shaft 5.

System 10 further includes an XYZ positioning assembly 40 and a probe assembly 90. System power 23 is controlled by power control 25. System 10 further includes a vibration control ballast 27. The entire system being dependent on system levelers 35. The system further is operated by any one or combination of handheld control 21 or computer control 19.

As demonstrated in FIG. 2, shoe mount assembly 50 includes drive belt 33 that is turned by motor 29, and belt 33 further turns drive pulley 31 of the system. Pneumatic cylinder 64 is utilized in imparting the desired vertical motion as indicated by arrow 63.

As demonstrated in FIG. 5, front base 61, when imparted with vertical motion as indicated by arrow 63, will move front station shoe assembly 59 vertical as desired, which will further impart motion and angular offset as demonstrated by rotational angle 67, upon carriage rail 55. Carriage rail 55 has on its distal end front pivot 53 with fastening pin 51, and pivot slot 57, such that pin 51 moves along slot 57 when front station 59 is moved upward or downward vertically as indicated by arrow 63. Rear station 37 is at the proximal end of carriage rail 55, whereby carriage rail 55 includes rear pivot 41, an identical fastening pin 51, as on the distal end of carriage rail 55. Rear stanchion 37 has formed therein positioning holes 39, constructed and arranged for desired height of attaching rear pivot 51 of carriage rail 55. These components being part of XYZ positioning assembly 40. The positioning assembly 40 being shoe mount assembly 50, further including shoe carriage 43, dependent on standoff 45 and straightening shoe 47. Connection bolt 49 connects standoff 45 to straightening shoe 47, ultimately used to straighten rim 1 in the system of the present invention. As demonstrated in FIG. 6, straightening shoe 47 contacts rim 1 at contact point 71.

The present invention further comprises a novel base frame 40, whereby base frame top mount plate 4A is constructed and arranged to deflect force, indicated by arrow F, when the system placed thereon is in use. In one embodiment, as demonstrated in FIG. 11, a wheel positioning system 200 includes a sling 205, whereby vertical drive assembly 201, being a worm gear or other appropriate vertical drive assembly, is included in frame 202. Frame 202 being a load and unload frame, whereby swivel connector 204 supports frame arm 203, and a wheel is selectively lifted into position or moved out of position as desired. FIG. 12 being subsequent from FIG. 11 demonstrating movement by arrows of a wheel into a work position or a load position as desired. Frame arm 203 rotates and positions the wheel as desired.

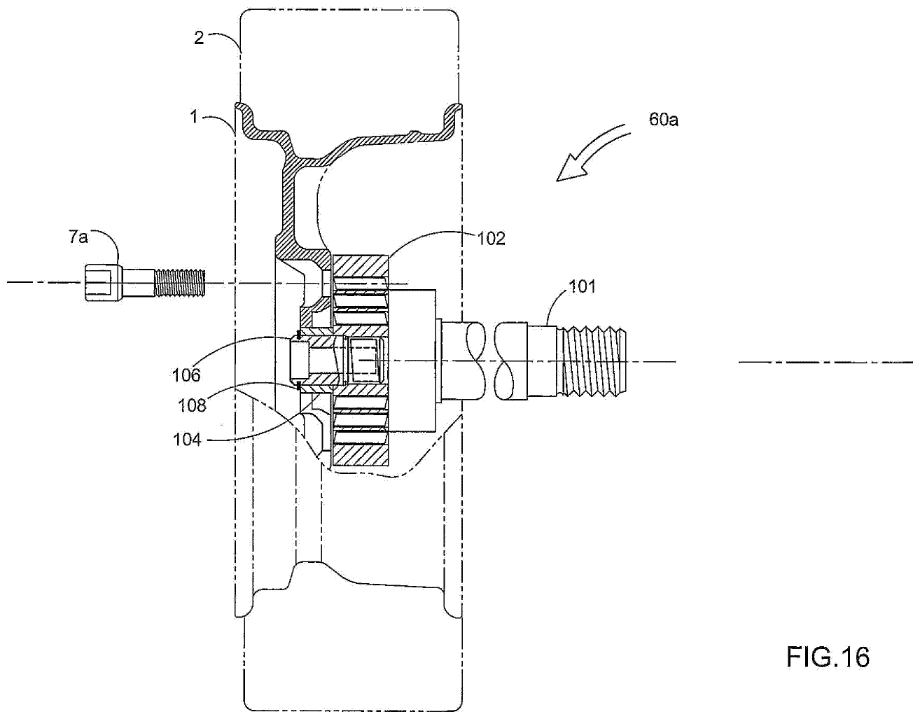

As demonstrated in FIG. 16, head stock assembly 60A demonstrates placement of rim 1 and securing thereof. In this embodiment, spindle 101 is constructed and arranged to support adapter ring 104. One unique feature of the present invention is that adapter ring 104 is provided in various size configuration depending on the rim to be prepared and/or make and model of a vehicle in which a particular rim is utilized. In use, a user will select with particularity adapter ring 104 and secure onto spindle 101. Further, ring centering adapter 106, using retainer ring 107, secures rim 1 into position. Once the wheel is centered as desired, mounting bolt 7A is utilized to secure rim 1 to bolt plate 102.

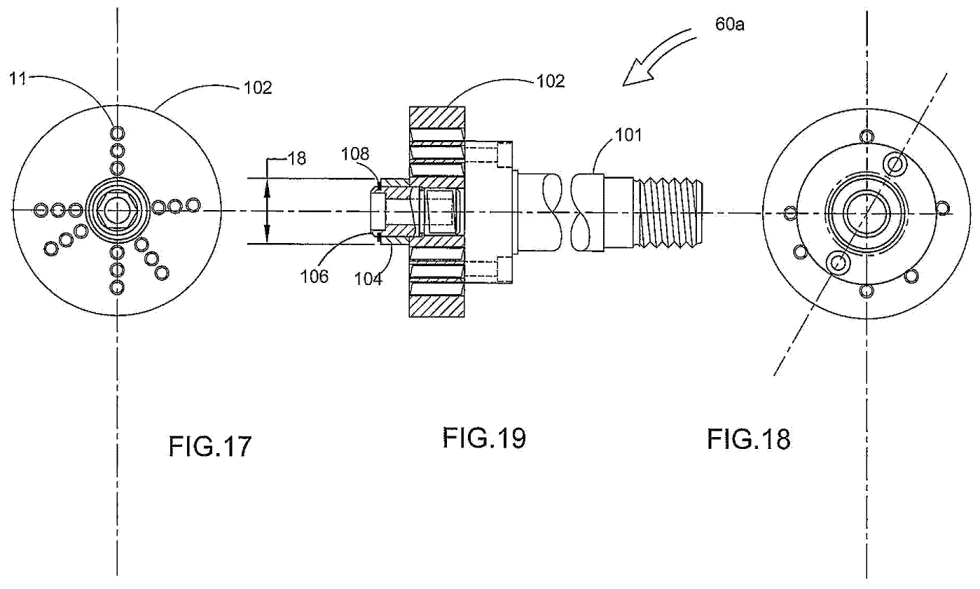

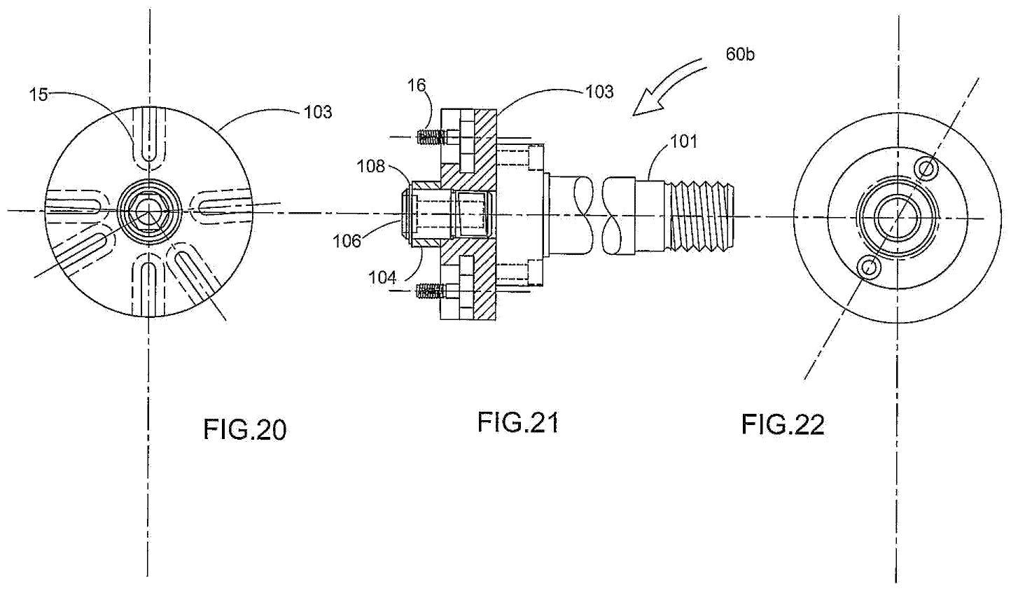

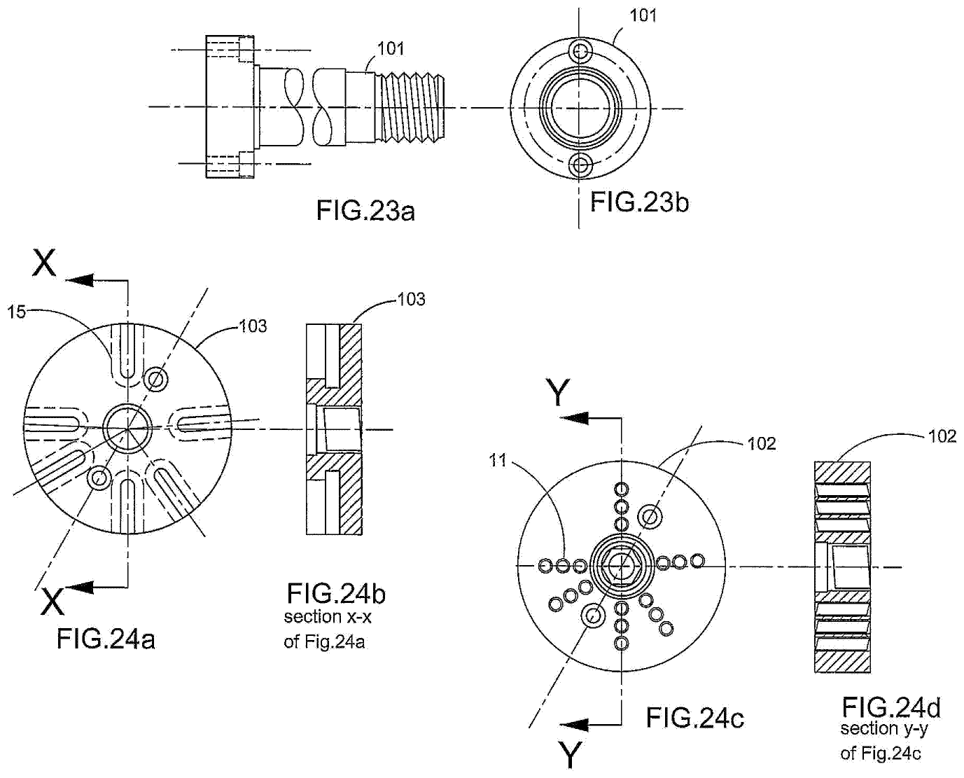

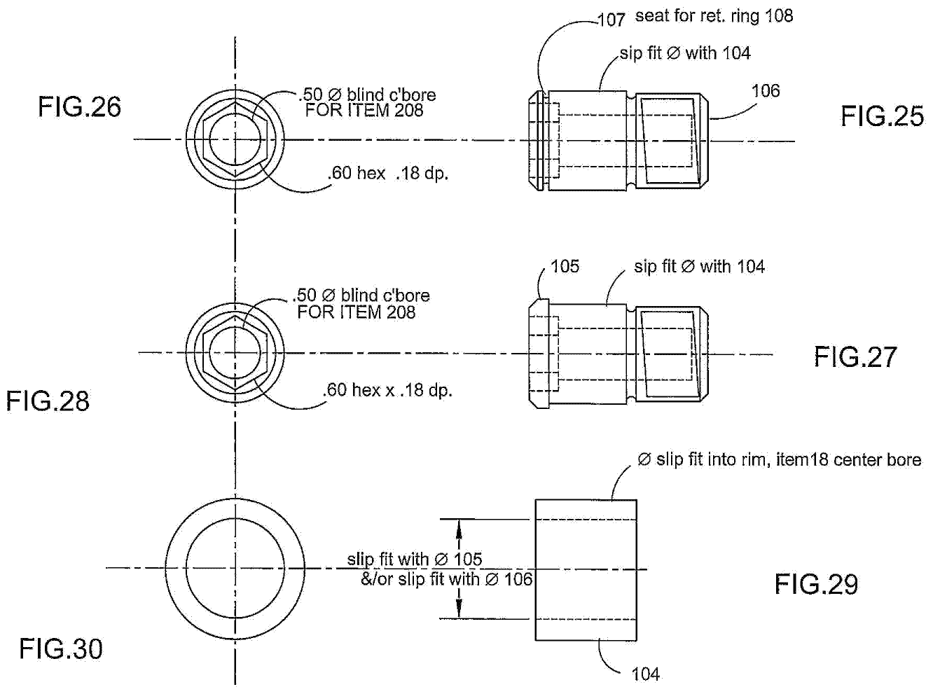

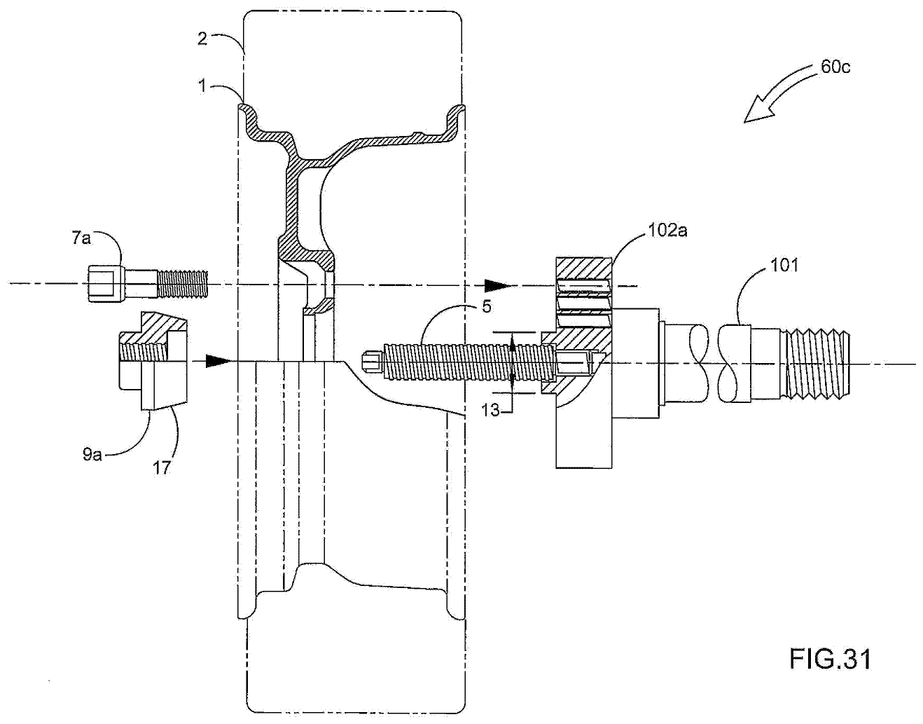

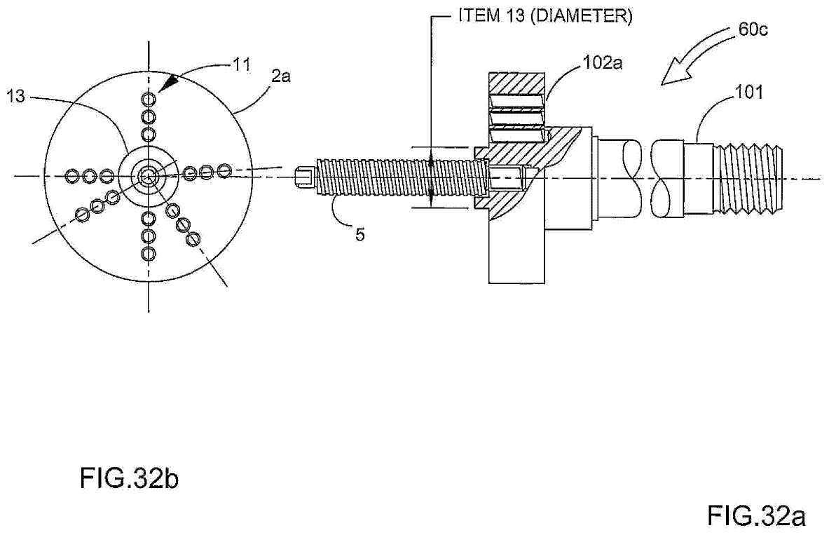

As demonstrated in FIGS. 17, 18, and 19, in one embodiment of the present invention, bolt plate 102 is formed with a particular bolt mounting pattern 11, as seen in FIG. 17. As demonstrated in FIGS. 20, 21, and 22, bolt plate 103 is constructed and arranged with a rim mounting slot system 15, utilized for T-bolt 16 in order to secure rim 1 into position.

Another unique feature of the present invention provides that the user can select bolt plate 102 or bolt plate 103, as they are interchangeable and utilized as desired by the user. In one embodiment, either one or both of bolt plate 102 and bolt plate 103 are configured in a customizable configuration dependent on rims to be utilized in the present invention.

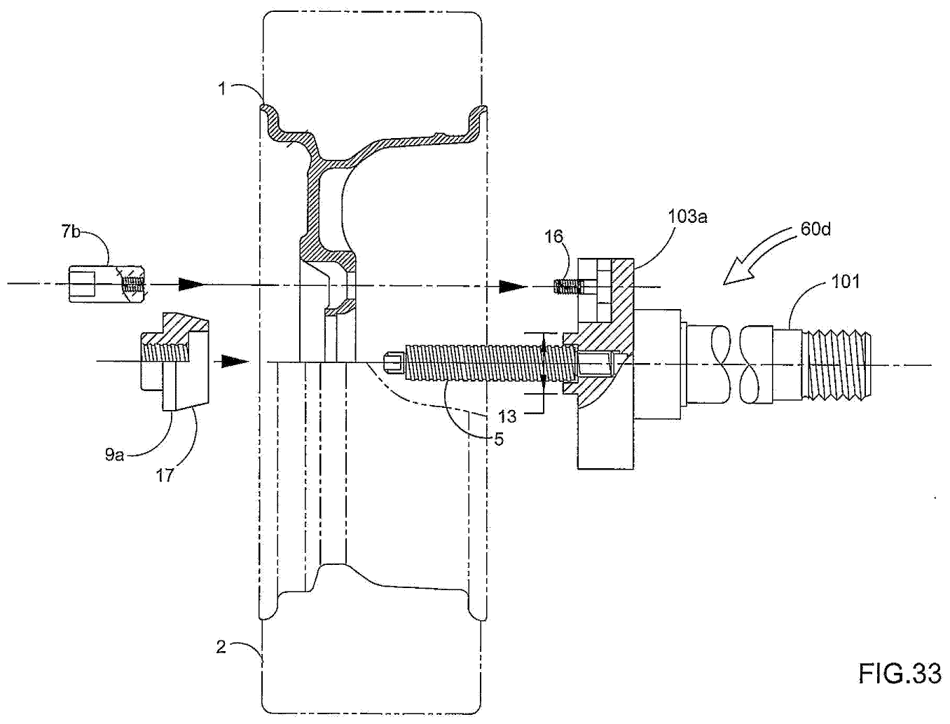

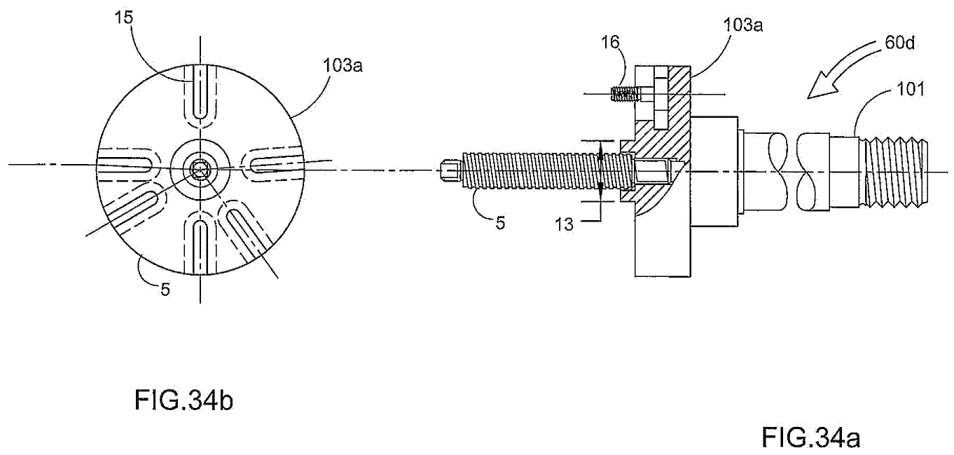

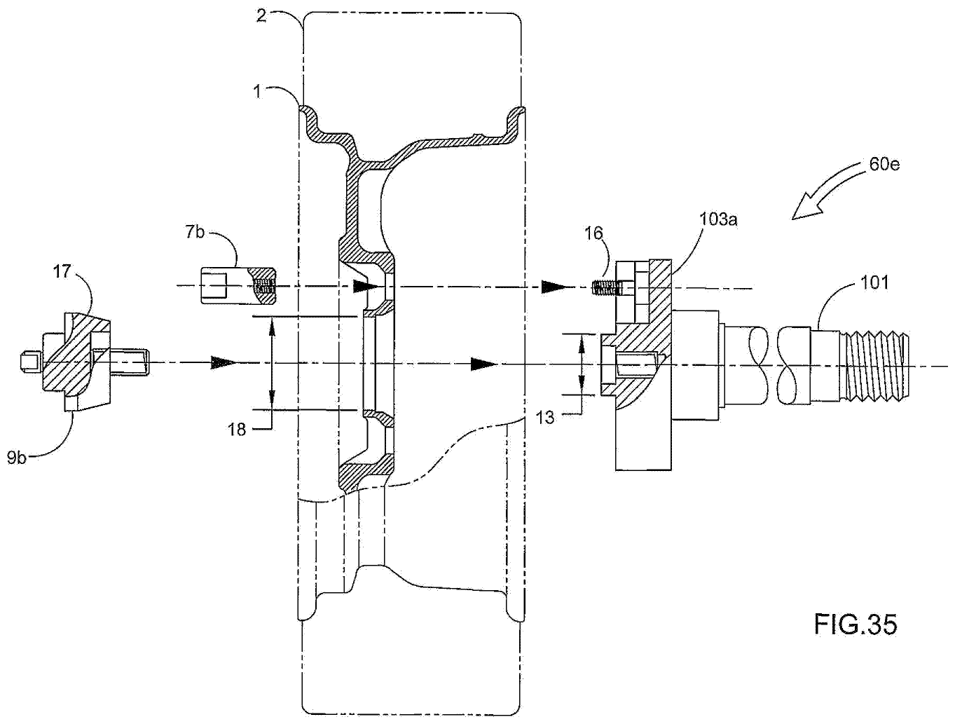

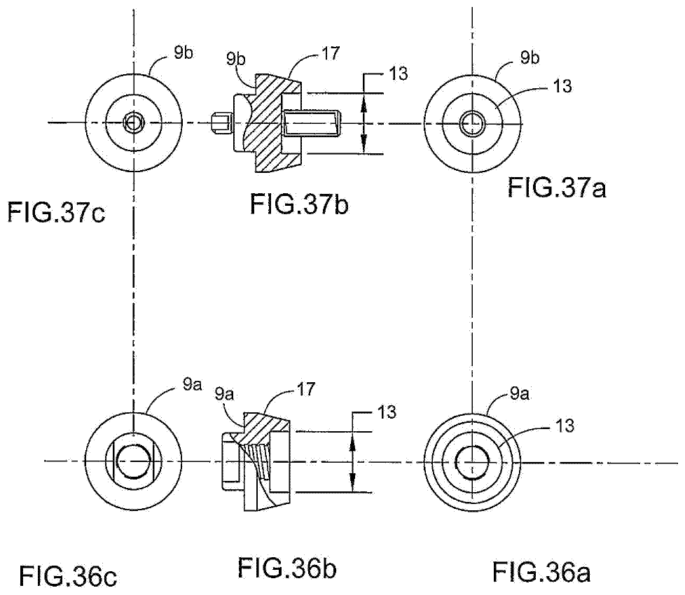

As demonstrated in FIG. 33, bolt plate 103A utilizes T-bolt 16 in securing rim 1, according to one embodiment of the present invention. The present invention contemplates user selectable or supplied varying head stock assemblies. Head stock assembly 60A, utilizing mounting bolt 7A, along with rim centering adapter 106, retaining ring 108, bolt plate 102, and spindle 101. Second headstock assembly 60B contemplates utilizing T-bolt 16, along with spindle 101, bolt plate 103, adapter ring 104, rim centering adapter 106, and retaining ring 108. Third headstock assembly 60C contemplates using mounting bolt 7A, centering cone 9A, center mount shaft 5, bolt plate 102A, with spindle 101. Fourth headstock assembly 60D contemplates utilizing centering cone 9A, mounting nut 7B, T-bolt 16, spindle 101, and bolt plate 103A. As generally understood, a user can use a centering cone 9A, a centering cone 9B, or any of the centering rings 104.

The present invention provides the unique configuration that a user can work on rim 1 either alone or rim 1 with tire 2 attached. Up until now, there are no machines existing that allow a user to work on a tire 2 with rim 1 in the manner disclosed herein. A significant improvement is the base system of the present invention that provides for vibrational dampening allowing for the precision required when working on rim 1 with tire 2 still mounted. Additionally, most known machines are using a jaw-type system to hold a rim in position in order for it to be repaired. The present invention provides for a central mounting system that has done away with the need for the jaw mounting system. The central mounting system, as described herein, with the spindle and varying attachments, provides for secure attachment and allowing for the precision of the system of the present invention to repair rim 1 as needed.

Prior attempts to provide a central mounting system in order to repair a rim have been unsuccessful. The present invention has discovered that when pairing the central mounting and securing system with the dampening base of the present invention, a user can successfully use a CNC or manual lathe to repair rim 1 as desired.

As demonstrated in the various figures, the system of the present invention represents a further improvement in that a CNC or manual lathe is utilized in a single machine with wheel-straightening components. Up until now, there has been no such machine to successfully incorporate each of these operations in a single unit. Currently, users are required to remove the wheel from one machine and mount on a second machine in order to perform each of these operations.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A machine being a mini wheel CNC and manual lathe with wheel straightener comprising:
a main body;
a spindle associated with said main body, said spindle turned by a motor connected to a power source;
a cutting tool holder;
a control operatively associated with said cutting tool holder, whereby said control is a user selectable manual or computer operated control;
a base having an upper surface stage and two vertically positioned side panels supporting said upper surface stage, said stage constructed and arranged to dampen vibration and exhibiting a maximum deflection load during operation less than 0.0444 inches.

2. The machine of claim 1 wherein said spindle is constructed and arranged to hold a workpiece.

3. The machine of claim 1 wherein said spindle is constructed and arranged to hold a tire on a rim.

4. The machine of claim 1 wherein said spindle is constructed and arranged to hold a tire rim with tire mounted.

5. The machine of claim 1 wherein said side panels exhibiting a maximum deflection load during operation less than 0.0666 inches.

6. The machine of claim 3 wherein said machine further includes a wheel straightening tool.

7. The machine of claim 6 wherein a user selects using one of said wheel straightening tool or said cutting tool.

8. The machine of claim 6 wherein a user powers on said machine and selects using one of said wheel straightening tool or said cutting tool and is able to switch from said wheel straightening tool or said cutting tool without stopping said machine or removing said rim.

9. The machine of claim 1 configured with said lathe oriented vertically relative to a user which would result in said tire or rim being positioned in a horizontal orientation.
